(19) United States
(12) Patent Application Publication
(10) Pub. No.: US 2023/0143297 A1
(43) Pub. Date: May 11, 2023

(54) PRODUCTION KNOWLEDGE MANAGEMENT SYSTEM, PRODUCTION KNOWLEDGE MANAGEMENT METHOD, AND PRODUCTION KNOWLEDGE MANAGEMENT PROGRAM

(71) Applicant: HITACHI, LTD., Tokyo (JP)

(72) Inventors: Miyuki KAWATA, Tokyo (JP); Seunghwan PARK, Tokyo (JP); Yoshiyuki TAKAMORI, Tokyo (JP)

(21) Appl. No.: 17/917,582

(22) PCT Filed: Mar. 16, 2021
(86) PCT No.: PCT/JP2021/010501

§ 371 Date: Oct. 7, 2022

(30) Foreign Application Priority Data
Apr. 8, 2020 (JP) 2020-069585

(51) Int. Cl. G06Q 10/0633; G06F 16/906; G06Q 50/04; G06F 16/903

(52) U.S. Cl. CPC G06Q 10/0633; G06F 16/906; G06Q 50/04; G06F 16/90344

(57) ABSTRACT

A database includes a classification master table which registers a classification name obtained by classifying processing performed in each process of a production line and a classification ID in association with each other, a process table which registers a process name of the process and a process ID in association with each other, a process order table which registers the process ID and a next process ID in association with each other, a process classification table which registers the process ID and the classification ID in association with each other, a knowledge table which registers a problem content occurring in each process, a factor thereof, and a knowledge ID in association with each other, and a knowledge classification table which registers the knowledge ID and the classification ID in association with each other.

### TECHNICAL FIELD

The present invention relates to a production knowledge management system, a production knowledge management method, and a production knowledge management program.

### BACKGROUND ART

As a background art of the present technical field, there is JP 2006-31213 A (PTL 1). This publication describes that “In the problem case registration search, a problem case in which a problem content and a countermeasure taken against the problem content are described is edited/created and registered in a problem case registration search device with respect to a problem event that occurred in the past, and a problem case serving as a reference can be searched/extracted and used from the registered problem case when necessary. In such a problem case registration search, regarding a plurality of constituent events constituting a problem event, one of the constituent events is set as a main event and the others are set as sub-events, an event chain in which the main event and the sub-events are associated with each other in a causal chain is edited and set for each problem case, and regarding the event chain set for each problem case, an event chain network in which the event chains common to the main events are associated with each other by the common main event is edited and set.” (see Abstract).

As another background art, there is JP 2007-241774 A (PTL 2). This publication describes that “The product/process model DB stores an integrated model in which a product structure information model and a process configuration information model are integrated. On the basis of this integrated model, in addition to the modeling of problems of the design model of the product, problems in preparation and manufacturing are also modeled. Further, since the integrated model expresses the process by the state transition, it is possible to express a problem occurrence mechanism based on a causal chain relationship of problems in the production system. The quality knowledge DB stores an entity/state data model in which each of an entity (unit/part) and a state (process) is expressed by an attribute and a method based on the integrated model, and is capable of systematically describing knowledge and know-how in a production system.” (see Abstract).

### CITATION LIST

### Patent Literature

PTL 1: JP 2006-31213 A

PTL 2: JP 2007-241774 A

### SUMMARY OF INVENTION

### Technical Problem

PTL 1 and PTL 2 disclose a technique of constructing a database of a tree structure by associating certain knowledge with other knowledge by a causal or parent-child definition.

However, when the knowledge obtained at various manufacturing sites is compiled into a database, there is a problem that a burden of work of constructing the database by applying the knowledge to a tree structure is large.

Therefore, an object of the present invention is to provide a production knowledge management system, a production knowledge management method, and a production knowledge management program capable of searching for knowledge using a database with a simple construction.

### Solution to Problem

In order to solve the above problem, an embodiment of the present invention includes: a database; and a search unit which searches the database, wherein the database includes: a classification master table which registers a classification name obtained by classifying processing performed in each process of a production line and a classification ID which is a unique key thereof in association with each other; a process table which registers a process name of the process and a process ID which is a unique key thereof in association with each other; a process order table which registers the process ID and a next process ID which is a unique key of a process next to a process indicated by the process in association with each other; a process classification table which registers the process ID and the classification ID in association with each other; a knowledge table which registers a problem content occurring in each process, a factor thereof, and a knowledge ID which is a unique key thereof in association with each other; and a knowledge classification table which registers the knowledge ID and the classification ID in association with each other, the search unit performs a first search for specifying a first related knowledge record group by receiving a problem keyword and a problem occurrence process, by using the database, narrowing records in the knowledge table by determination of similarity of a character string between the problem keyword and the problem content stored in the knowledge table, and arranging an order of the narrowed records such that a record more related to the classification name in the problem occurrence process or a process upstream of the problem occurrence process in the production line is prioritized.

### Advantageous Effects of Invention

According to the present invention, it is possible to provide a production knowledge management system, a production knowledge management method, and a production knowledge management program capable of searching for knowledge using a database with a simple construction.

Problems, configurations, and effects other than those described above will be clarified by the following description of embodiments.

### BRIEF DESCRIPTION OF DRAWINGS

FIG. 1 is a block diagram illustrating a system configuration of a production knowledge management system according to a first embodiment of the present invention.

FIG. 2 is a functional block diagram of the production knowledge management system according to the first embodiment.

FIG. 3 is a table configuration diagram of the production knowledge management system according to the first embodiment.

FIG. 4 is a conceptual diagram of a classification master table of the production knowledge management system according to the first embodiment.

FIG. 5 is a conceptual diagram of a process table of the production knowledge management system according to the first embodiment.

FIG. 6 is a conceptual diagram of a process order table of the production knowledge management system according to the first embodiment.

FIG. 7 is a conceptual diagram of a process classification table of the production knowledge management system according to the first embodiment.

FIG. 8 is a conceptual diagram illustrating a process flow of a sample for explaining processing of the production knowledge management system according to the first embodiment.

FIG. 9 is a conceptual diagram of a knowledge table of the production knowledge management system according to the first embodiment.

FIG. 10 is a conceptual diagram of a knowledge classification table of the production knowledge management system according to the first embodiment.

FIG. 11 is a plan view of a knowledge registration screen used in the production knowledge management system according to the first embodiment.

FIG. 12 is a plan view of a knowledge list screen used in the production knowledge management system according to the first embodiment.

FIG. 13 is a conceptual diagram of a table and a view stored in a search information storage unit used in the production knowledge management system according to the first embodiment.

FIG. 14 is a plan view of a knowledge search screen used in the production knowledge management system according to the first embodiment.

FIG. 15 is a flowchart of search processing executed by the production knowledge management system according to the first embodiment.

FIG. 16 is a conceptual diagram of an inter-process node number table of the production knowledge management system according to the first embodiment.

FIG. 17 is a conceptual diagram of a most upstream node number view generated by the production knowledge management system according to the first embodiment.

FIG. 18 is a conceptual diagram of a node number classification view generated by the production knowledge management system according to the first embodiment.

FIG. 19 is a conceptual diagram of a nearest classification view generated by the production knowledge management system according to the first embodiment.

FIG. 20 is a conceptual diagram of a first-stage candidate view generated by the production knowledge management system according to the first embodiment.

FIG. 21 is a conceptual diagram of a first-stage arrangement order determination view generated by the production knowledge management system according to the first embodiment.

FIG. 22 is a conceptual diagram illustrating a method of determining <first-stage node number> and <first-stage process ID> in the production knowledge management system according to the first embodiment.

FIG. 23 is a conceptual diagram of a second-stage candidate view generated by the production knowledge management system according to the first embodiment.

FIG. 24 is a conceptual diagram of a second-stage arrangement order determination view generated by the production knowledge management system according to the first embodiment.

FIG. 25 is a conceptual diagram illustrating a method of determining <second-stage node number> and <second-stage process ID> in the production knowledge management system according to the first embodiment.

FIG. 26 is a conceptual diagram of a third-stage candidate view generated by the production knowledge management system according to the first embodiment.

FIG. 27 is a conceptual diagram of a third-stage arrangement order determination view generated by the production knowledge management system according to the first embodiment.

FIG. 28 is a conceptual diagram illustrating a method of determining <third-stage node number> and <third-stage process ID> in the production knowledge management system according to the first embodiment.

FIG. 29 is a functional block diagram of a production knowledge management system according to a second embodiment of the present invention.

FIG. 30 is a plan view of a knowledge search screen used in a production knowledge management system according to a third embodiment.

FIG. 31 is a flowchart of search processing executed by the production knowledge management system according to the third embodiment.

FIG. 32 is a block diagram illustrating network connection between a production knowledge management system and a production state monitoring system according to the fourth embodiment.

FIG. 33 is a conceptual diagram of an error knowledge table used in the production knowledge management system according to the fourth embodiment.

FIG. 34 is a conceptual diagram of an error occurrence process table used in the production knowledge management system according to fourth embodiment.

### DESCRIPTION OF EMBODIMENTS

Hereinafter, embodiments of the present invention will be described with reference to the drawings.

### First Embodiment

[Overall Configuration]

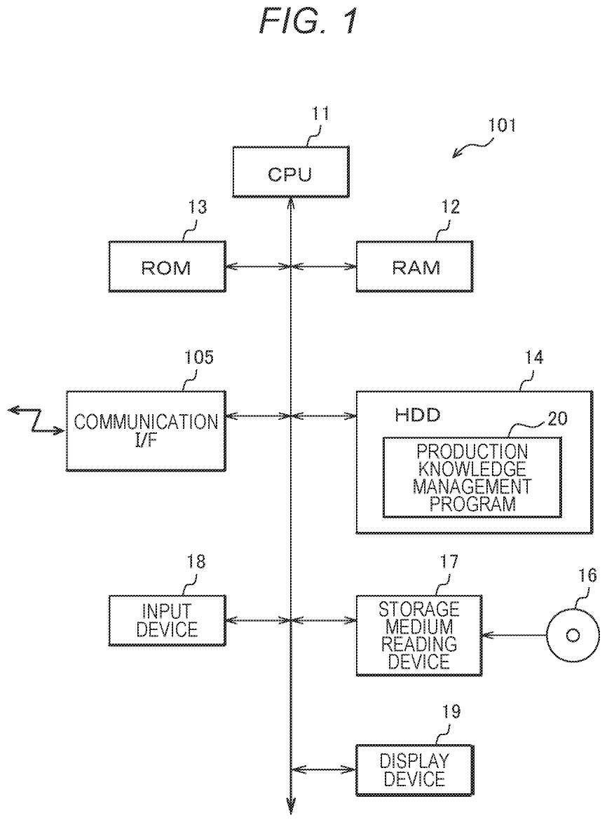

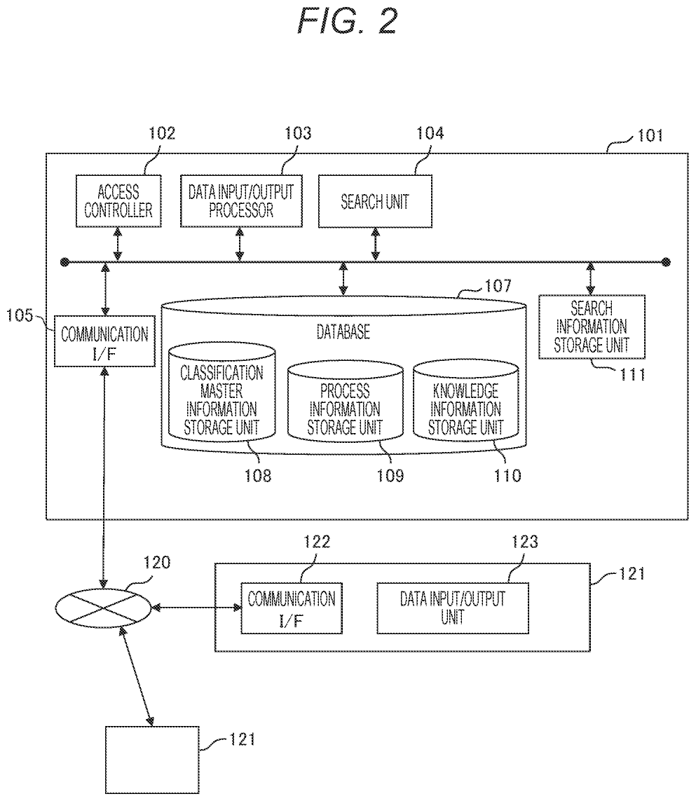

FIG. 1 is a block diagram illustrating a system configuration of a production knowledge management system 101 according to a first embodiment of the present invention. The production knowledge management system 1 is a database system. The production knowledge management system 101 includes a central processing unit (CPU) 11 that performs various calculations and intensively controls each unit of the production knowledge management system 101. A random access memory (RAM) 12 which is a work area of the CPU 11, a ROM 13 in which a basic input output system (BIOS) and the like are stored, and a magnetic storage device (HDD) 14 (which may be a solid state drive (SSD) and the like) which is a nonvolatile storage device for storing various data are connected to the CPU 11. Further, a communication interface (I/F) 105 for communicating with a network 120 (FIG. 2) such as the Internet, and a storage medium reading device 17 such as an optical disk device for reading data of a storage medium 16 which is various media such as a Blu-ray (registered trademark) disc, a digital versatile disc (DVD), and a compact disc (CD) are connected to the CPU 11. Furthermore, an input device 18 such as a keyboard, a mouse, and the like, and a display device 19 such as a liquid crystal display, an organic EL display, and the like are connected to the CPU 11. A production knowledge management program 20 is set up in the magnetic storage device 14. The production knowledge management program 20 may be downloaded from the Internet or the like and set up in the magnetic storage device 14, or may be read from the storage medium 16 by the storage medium reading device 17 and set up in the magnetic storage device 14.

In FIG. 1, for convenience, the production knowledge management system 101 is illustrated as a single server device, but may be implemented as a plurality of server devices on a network that operate in cooperation with each other. In this case, the production knowledge management program 20 illustrated in FIG. 1 as a set of data is also an aggregate of program groups set up in a distributed manner in a plurality of server devices. In this case, the storage medium 16 is also an aggregate of storage medium groups including storage media corresponding to the respective server devices.

The production knowledge management system 101 operates based on the production knowledge management program 20, constructs a database 107 (FIG. 2) to be described later in the magnetic storage device 14 or another non-volatile storage device, and can search the database 107. The production knowledge management system 101 is a database that is used at a certain production site and registers various problem cases in order to solve a problem occurring in a production line at the production site. In the present specification, the term “process” refers to a process in a production line. Furthermore, the term “upstream” refers to upstream viewed form a certain process in a production line.

FIG. 2 is a functional block diagram of the production knowledge management system 101. The production knowledge management system 101 constructs a database 107, and a classification master information storage unit 108, a process information storage unit 109, and a knowledge information storage unit 110 are provided in the database 107. A data input/output processor 103 inputs and outputs data relative to the database 107. A search unit 104 performs search processing of the database 107. A search information storage unit 111 stores search information obtained by searching the database 107.

In order to access the production knowledge management system 101, a terminal device 121 connected to the production knowledge management system 101 through the network 120 is used. The terminal device 121 includes a communication I/F 122 that communicates with the production knowledge management system 101 via the network 120 and a data input/output unit 123 through which a user of the terminal device 121 inputs and outputs data. An access controller 102 controls access from the terminal device 121 via the communication I/F 105 and the network 120.

Meanwhile, PTL 1 and PTL 2 described above disclose a technique of constructing a database of a tree structure by associating certain knowledge with other knowledge by a causal or parent-child definition. However, such a technology has the following problems.

(a) In the techniques of PTL 1 and PTL 2, when searching for other knowledge from a certain knowledge A, only knowledge connected to the knowledge A in advance in a tree structure can be extracted. However, knowledge obtained at production sites of various products often has no certainty of causality in the middle, and a burden of work of applying knowledge to the tree structure is large. Therefore, it is difficult to construct the database with the tree structure of knowledge.

(b) In the techniques of PTL 1 and PTL 2, it is difficult for a plurality of persons to accumulate knowledge without discussion because the recognition of the granularity of the tree structure, such as whether to divide the knowledge into several pieces of connected knowledge or combine the knowledge into one piece of knowledge, differs depending on persons. Therefore, also in this respect, it is difficult to construct the database with the tree structure of knowledge.

Therefore, in the following, a system and a processing process (production knowledge management method) that enable search of knowledge using a database with easy construction in the production knowledge management system 101 (production knowledge management program 20) will be described in detail.

[Database]

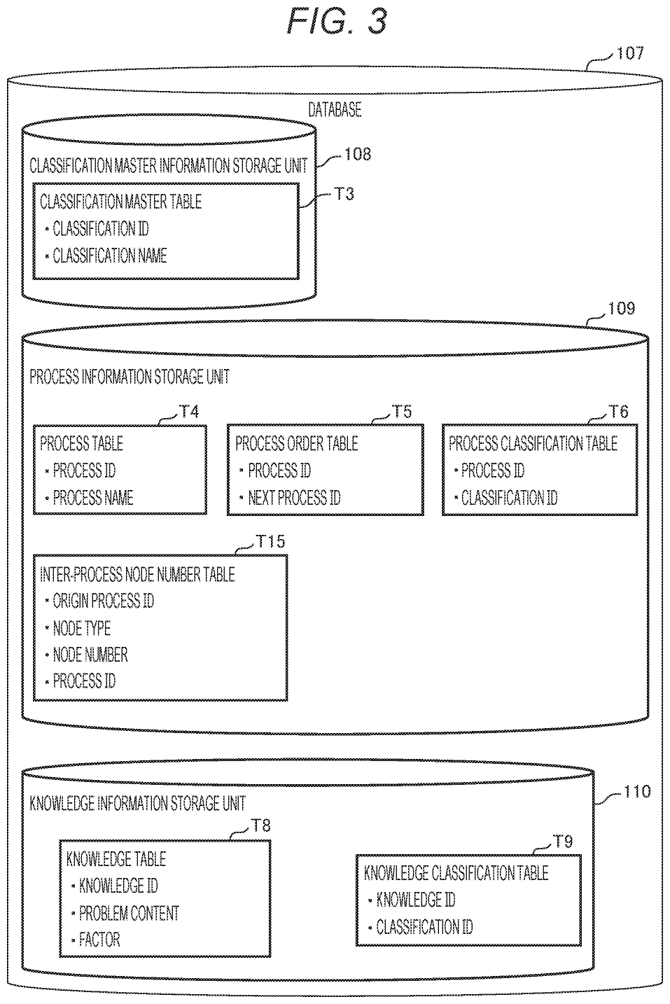

FIG. 3 is a block diagram illustrating types and relationships of tables stored in the database 107. The classification master information storage unit 108 stores a classification master table T3. The process information storage unit 109 stores a process table T4, a process order table T5, a process classification table T6, and an inter-process node number table T15. The knowledge information storage unit 110 stores a knowledge table T8 and a knowledge classification table T9.

The details of each table will be described below. Note that, in the present specification, information in units of rows stored in a table or a view is referred to as a “record”. Here, a table means a record group held in a state in which a value is fixed, and a view means a record group in a state in which processing is performed by temporarily referring to a part or the whole of the table. In addition, a column name defined by each table or view is described by surrounding it by <>. In addition, a value serving as the content of a record used as a sample of the embodiment is described by enclosing it with “”.

[Classification Master Information Storage Unit 108]

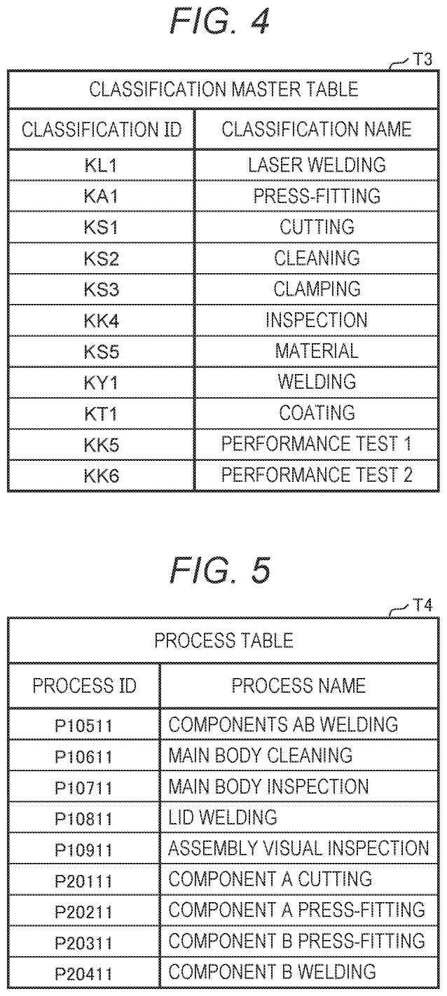

FIG. 4 is a conceptual diagram of the classification master table T3. The classification master table T3 is a table in which <classification name> as a record and <classification ID> which is a unique key of the record are associated with each other.

<Classification name> is a classification name obtained by classifying processing performed in various processes in a production line. In principle, this classification name does not include a unique field terminology used only in a specific production line, and it is desirable that the classification name is configured by a general-purpose term (generic name) that is commonly used at least in a production line of the same type of products.

In the classification master table T3, a server administrator registers records in advance through the data input/output processor 103 before the operation of the production knowledge management system 101 is started, and thereafter, the server administrator adds and changes the records through the data input/output processor 103 as necessary.

[Process Information Storage Unit 109]

FIG. 5 is a conceptual diagram of the process table T4. In the process table T4, <process name> as a record and <process ID> which is a unique key of the record are registered in association with each other. <Process name> is a notation of a name of each process in the production line, and unlike the classification name in FIG. 4, a unique field terminology used only in a specific production line may also be included.

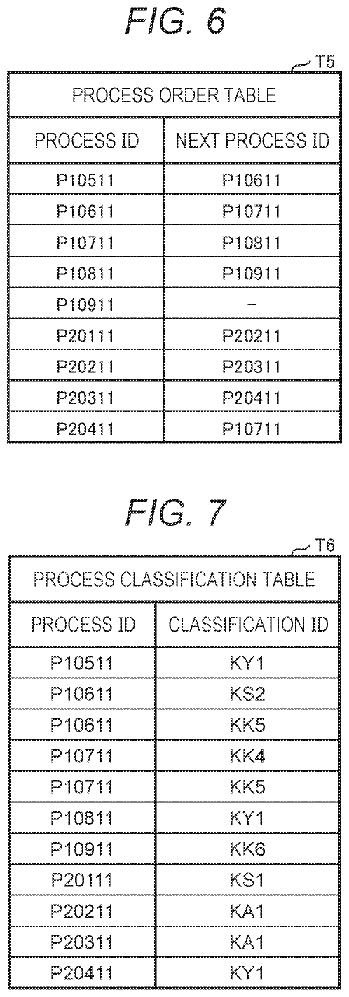

FIG. 6 illustrates a process order table T5 in which a process order in a production line is registered.

Although the definition of the process order may be another method such as numbering, in the first embodiment, the process order is defined by association between <process ID> and <next process ID>. <Next process ID> is a <process ID> of a process next to the process indicated by <process ID>.

As described above, the method of associating <process ID> with <next process ID> can also define a process flow in which a process branches or processes are joined in the middle of a production line. Both <process ID> and <next process ID> are values selected from <process ID> in the process table T4 (FIG. 5).

FIG. 7 illustrates a process classification table T6. The process classification table T6 stores <process ID> of the process table T4 (FIG. 5) and <classification ID> of the classification master table T3 (FIG. 4) in association with each other. This association may be one-to-many, many-to-one. For example, in the sample illustrated in FIG. 7, <process ID> of “P10611” is associated with two <classification IDs> of “KS2” and “KK5”. Further, three <process IDs> of “P10511”, “P10811”, and “P20411” are associated with a <classification ID> of “KY1”.

The above process information is information determined at a stage before design of a production line is completed and production is started at a manufacturing site. Therefore, the server administrator registers the records in the process table T4 (FIG. 5), the process order table T5 (FIG. 6), and the process classification table T6 (FIG. 7) by the data input/output processor 103 before the operation of the production knowledge management system 101 is started. Thereafter, when the contents of the processes constituting the production line are changed, such as in a change in product specifications and an improvement in a manufacturing method, and the like, the server administrator adds and changes the records by the data input/output processor 103.

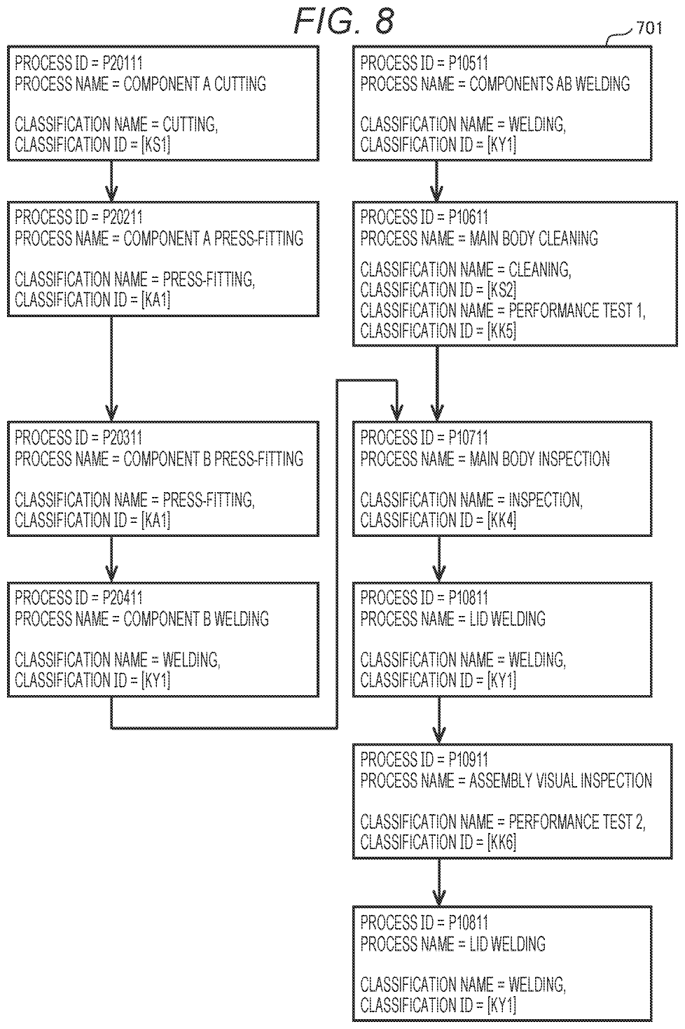

FIG. 8 is a conceptual diagram showing information regarding a process stored in each table of FIGS. 5 to 7 for a sample (an example of a production line) shown in the first embodiment. In FIG. 8, each box shows an individual process 701 in the production line (In FIG. 8, a reference sign is added to only one box.). <Process ID>, <process name>, <classification name>, and <classification ID> were described in each box. An arrow connecting boxes indicates the flow of each process 701 in the production line. As illustrated in FIG. 8, because of the process table T4 (FIG. 5) and the process order table T5 (FIG. 6), the flow of each process in the production line is clear. <Classification name> associated with each <process name> is also clear from the process classification table T6 (FIG. 7) and the classification master table T3 (FIG. 4).

The inter-process node number table T15 (FIG. 3) will be described later.

[Knowledge Information Storage Unit 110]

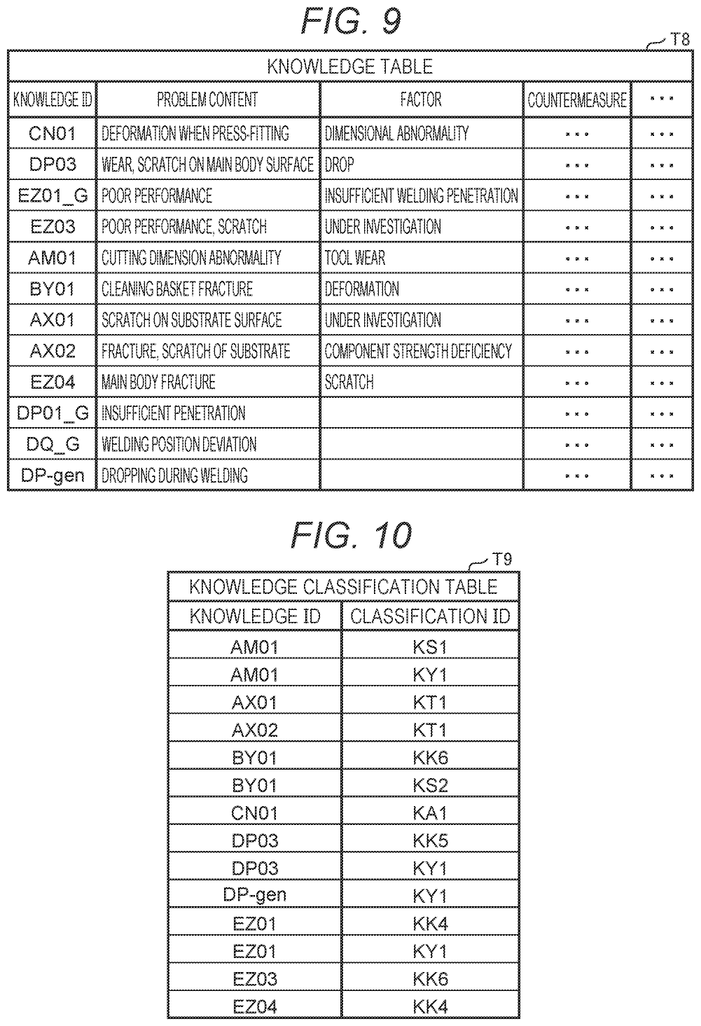

FIG. 9 is a conceptual diagram of the knowledge table T8. The knowledge table T8 is configured by associating <problem content>, <factor>, and <knowledge ID> which is a unique key of these records. In addition, a column describing the content of knowledge in detail, such as <countermeasure>, and the like may be additionally associated with them.

FIG. 10 is a conceptual diagram of the knowledge classification table T9. The knowledge classification table T9 is information that is searched at the production site and is used as a reference for countermeasures against problems. As a column to be added to the knowledge classification table T9 in addition to those illustrated in FIG. 10, the exhibit information of information, the storage destination of photographs, materials, and the like, the responsible person, the registrant of the knowledge record, the registration date and time, and the like are exemplified.

<Problem content> in the knowledge table T8 (FIG. 9) indicates contents of various problems that may occur in the production line (occurred in the past or expected to occur in the future). <Factor> indicates contents (within a known range) of a factor causing the associated <problem content>. <Countermeasure> indicates contents of a countermeasure against the associated <problem content>. <Problem content>, <factor>, <countermeasure>, and the like may include a unique field terminology used only for a specific production line.

The knowledge classification table T9 stores information related to association between <knowledge ID> of the knowledge table T8 (FIG. 9) and <classification ID> of the classification master table T3 (FIG. 4). The association may be one-to-many, many-to-one. For example, in the sample illustrated in FIG. 10, <knowledge ID> of “AM01” is associated with two <classification IDs> of “KS1” and “KY1”. In addition, two <knowledge IDs> of “AX01” and “AX02” are associated with <classification ID> of “KT1”.

<Process ID> and the <knowledge ID> are associated by the knowledge classification table T9 (FIG. 10) and the process classification table T6 (FIG. 7). Therefore, <process name> is associated with <problem content>, <factor>, and <countermeasure>. In addition, <classification name> is further associated with them (FIGS. 4 to 7, 9, and 10).

[Knowledge Registration Screen 1001]

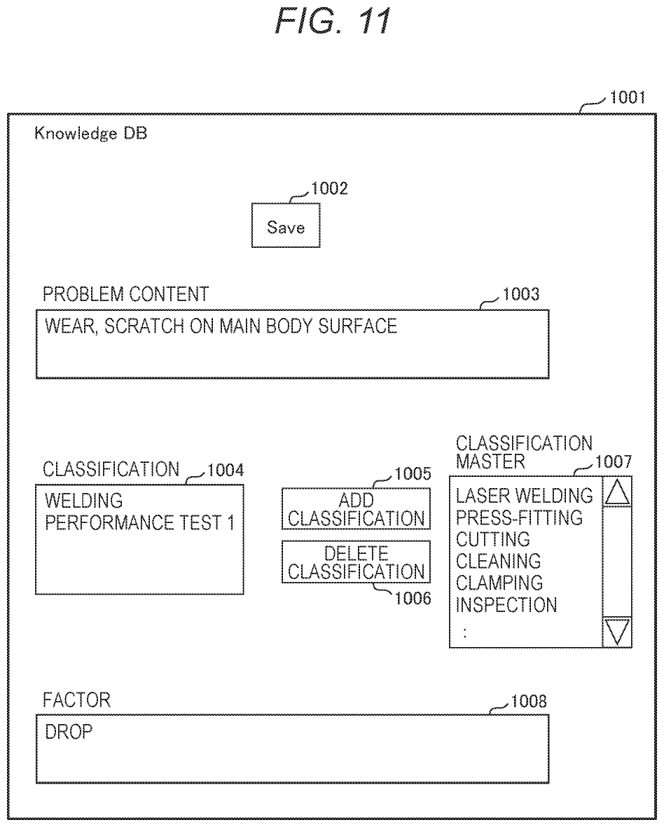

FIG. 11 is a plan view of the knowledge registration screen 1001 displayed on a display of the terminal device 121 via the data input/output unit 123. By accessing the production knowledge management system 101 with the terminal device 121, a user can display the knowledge registration screen 1001 on the own terminal device 121.

As illustrated in FIG. 11, the knowledge registration screen 1001 includes a save button 1002, a problem content input field 1003, a classification display field 1004, a classification addition button 1005, a classification deletion button 1006, a classification selection field 1007, and a factor input field 1008.

The user can add, edit, and delete records to and from the knowledge table T8 (FIG. 9) and the knowledge classification table T9 (FIG. 10) at any time using the knowledge registration screen 1001.

On the knowledge registration screen 1001, the contents of a record associated with each other in the knowledge table T8 (FIG. 9) are displayed.

In the problem content input field 1003, <problem content> of the knowledge table T8 is displayed in a state where the contents can be edited on the knowledge registration screen 1001.

In the classification display field 1004, <classification names> of all records are displayed in a selectable state from the classification master table T3 (FIG. 4) on the basis of <classification ID> of the knowledge classification table T9.

For example, FIG. 11 illustrates a state in which a record of <knowledge ID>=“DP03” illustrated in the knowledge table T8 (FIG. 9) is displayed.

<Classification name> of the classification master table T3 (FIG. 4) is displayed in a selectable state in the classification selection field 1007.

When a click of the classification addition button 1005 is detected, if there is a <classification name> selected in the classification selection field 1007, the <classification name> is added to the classification display field 1004 and displayed.

For example, if the user selects “press-fitting” in the classification selection field 1007 and then clicks the classification addition button 1005 in the state of FIG. 11, “welding, performance inspection 1, press-fitting” is displayed in the classification display field 1004.

When a click of the classification deletion button 1006 is detected, if there is a <classification name> selected in the classification display field 1004, the <classification name> is deleted from the classification display field 1004.

For example, if the user selects “welding” in the classification display field 1004 and then clicks the classification deletion button 1006 in the state of FIG. 11, only “performance inspection 1” is displayed in the classification display field 1004.

The factor input field 1008 displays <factor> of the knowledge table T8 (FIG. 9) in a state where the contents can be edited on the screen.

When the save button 1002 is clicked, the data input/output processor 103 updates <problem content> and <factor> in the knowledge table T8 (FIG. 9) to the contents displayed in the problem content input field 1003 and the factor input field 1008.

In addition, the data input/output processor 103 adds or deletes a record to or from the knowledge classification table T9 (FIG. 10) so as to match the content displayed in the classification display field 1004.

In a case where a column is added to the knowledge table T8 (FIG. 9), an input field for registering and editing the contents of the added column can be provided on the knowledge registration screen 1001.

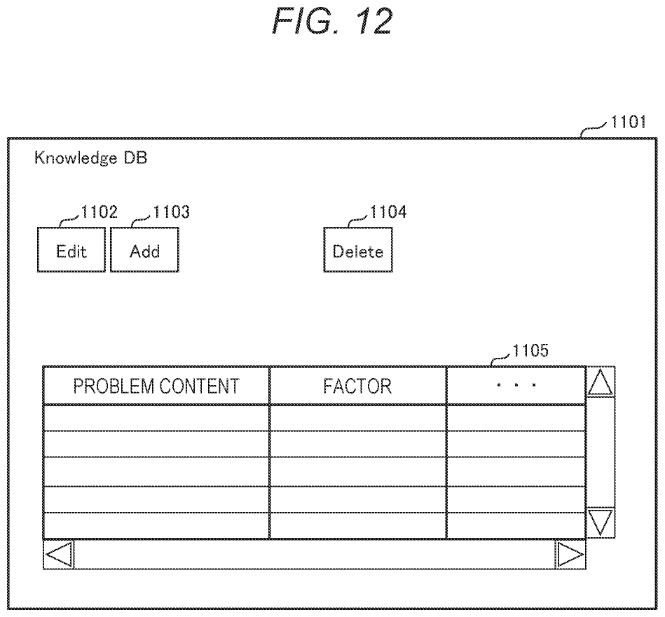

FIG. 12 is a plan view of the knowledge list screen 1101 displayed on the display of the terminal device 121 via the data input/output unit 123.

The knowledge list screen 1101 includes an edition button 1102, an addition button 1103, a deletion button 1104, and a knowledge list display field 1105.

In the knowledge list display field 1105, <problem content> and <factor> of all records of the knowledge table T8 (FIG. 9) can be displayed in a selectable state.

When the edition button 1102 is clicked, if there is a record selected in the knowledge list display field 1105, the data input/output unit 123 (FIG. 2) opens the knowledge registration screen 1001 (FIG. 11) in a state where the record is displayed.

When the addition button 1103 is clicked, the data input/output unit 123 opens the knowledge registration screen 1001 in which the problem content input field 1003, the classification display field 1004, and the factor input field 1008 are blank.

When a click of the deletion button 1104 is detected, if there is a record selected in the knowledge list display field 1105, first, a record of the same <knowledge ID> is deleted from the knowledge classification table T9 (FIG. 10) on the basis of <knowledge ID> of the record. Next, a record of the same <knowledge ID> is deleted from the knowledge table T8 (FIG. 9).

As described above, the user can accumulate information in the knowledge information storage unit 110 by operating the terminal device 121 at any time.

As described above, in a case where a column is added to the knowledge table T8 (FIG. 9), the added column is also displayed.

[Search Information]

The search information storage unit 111 (FIG. 2) is a memory area that temporarily stores records extracted and processed from the database 107 (FIG. 2) on the basis of search conditions in search processing executed by the search unit 104 (FIG. 2) described later.

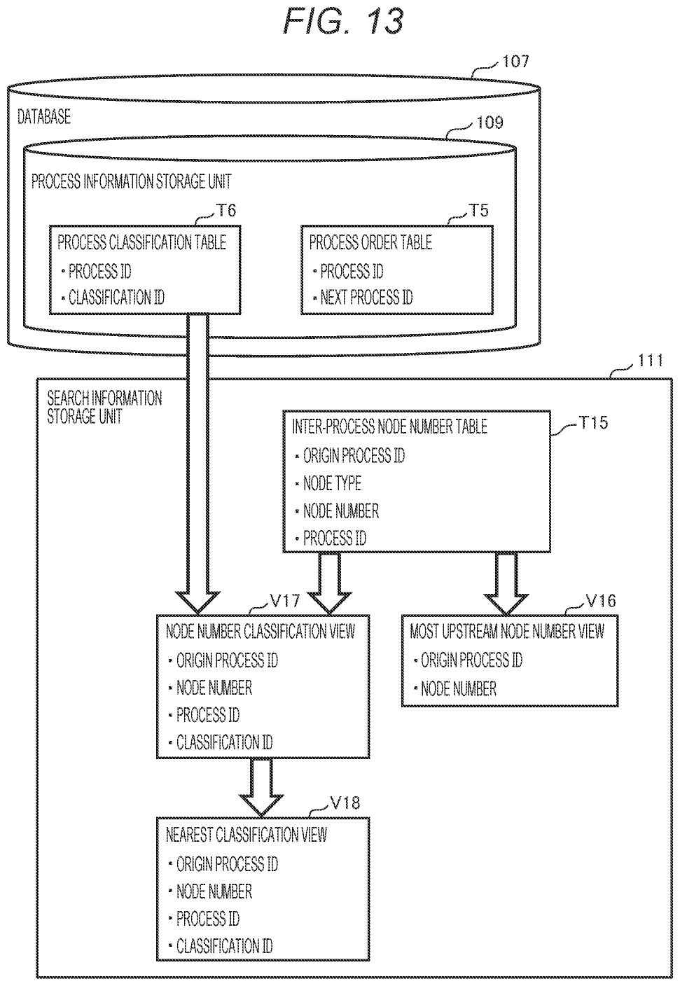

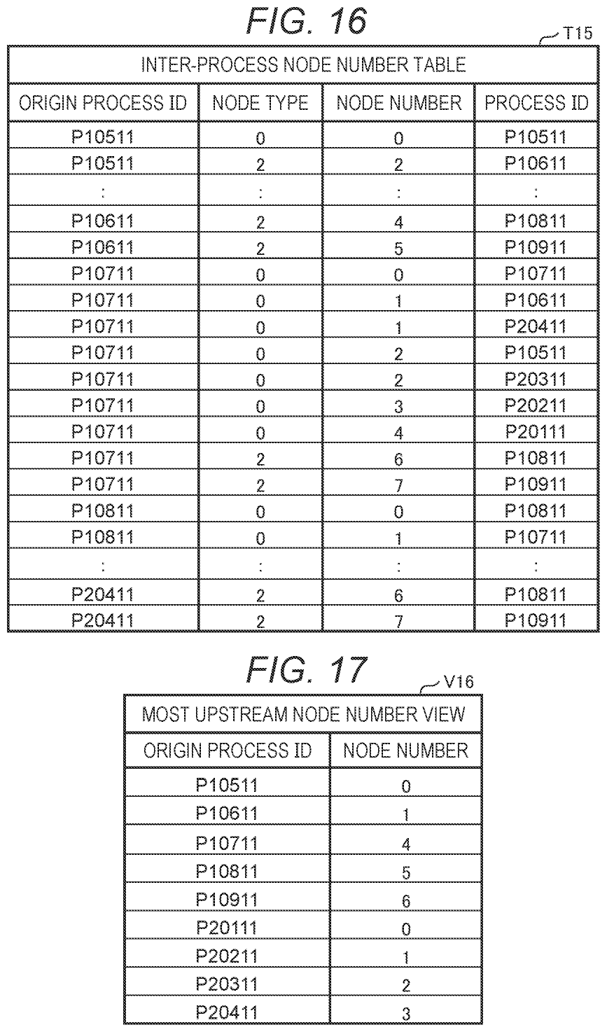

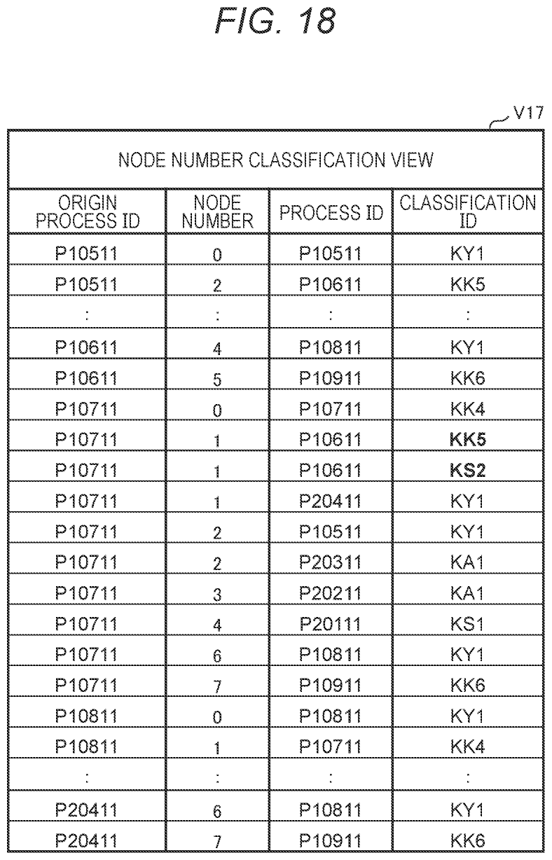

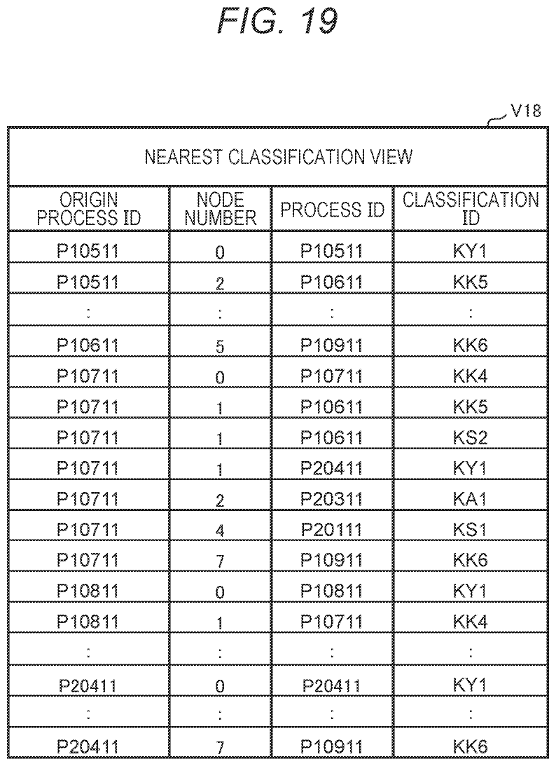

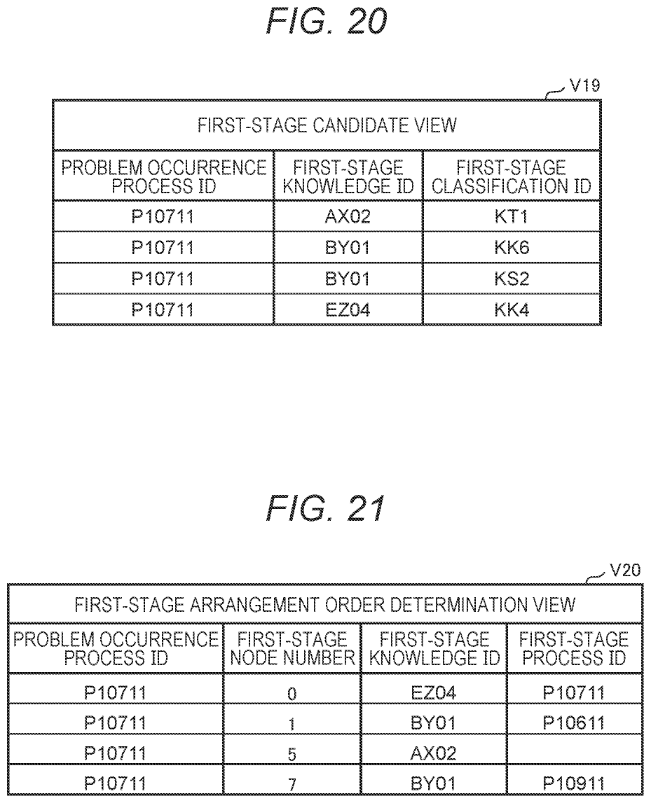

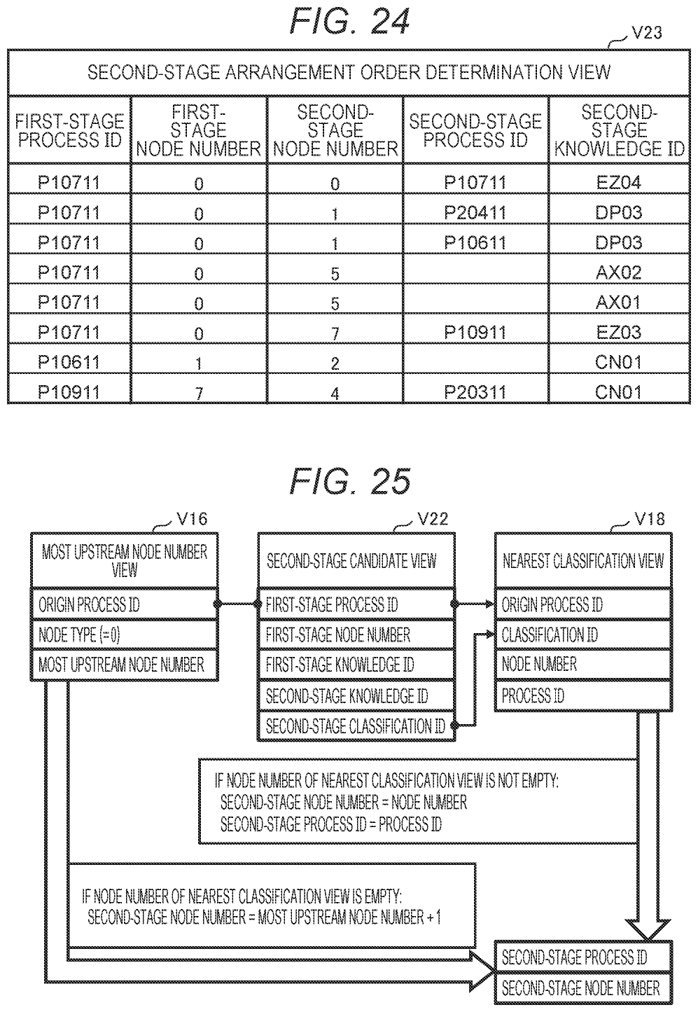

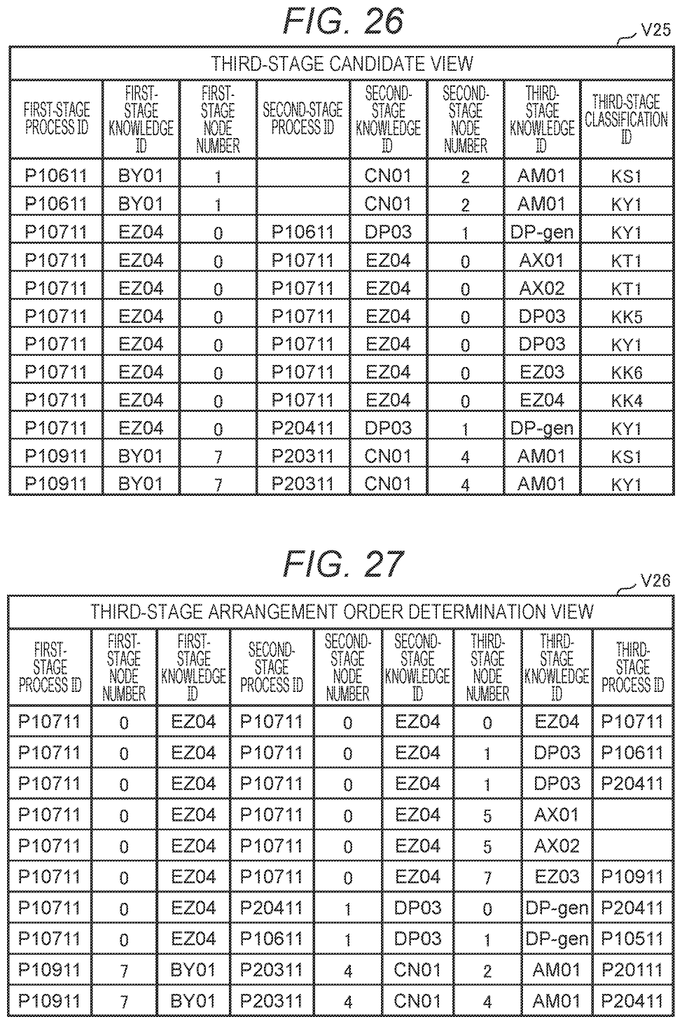

FIG. 13 illustrates a conceptual diagram of a table and a view stored in the search information storage unit 111. The search information storage unit 111 temporarily stores an inter-process node number table T15 (FIG. 16), a most upstream node number view V16 (FIG. 17), a node number classification view V17 (FIG. 18), a nearest classification view V18 (FIG. 19), and a first-stage candidate view V19 (FIG. 20). In addition, the search information storage unit 111 temporarily stores a first-stage arrangement order determination view V20 (FIG. 21), a second-stage candidate view V22 (FIG. 23), an arrangement order determination view V23 (FIG. 24), a third-stage candidate view V25 (FIG. 26), and a third-stage arrangement order determination view V26 (FIG. 27). In FIG. 13, only a part thereof is illustrated.

In FIG. 13, an arrow indicates a reference relationship between a view and a table. For example, the nearest classification view V18 is a view obtained by referring to and processing a record of the node number classification view V17. Details of each table and view will be described in the description of [Search processing] to be described later.

[Search Screen]

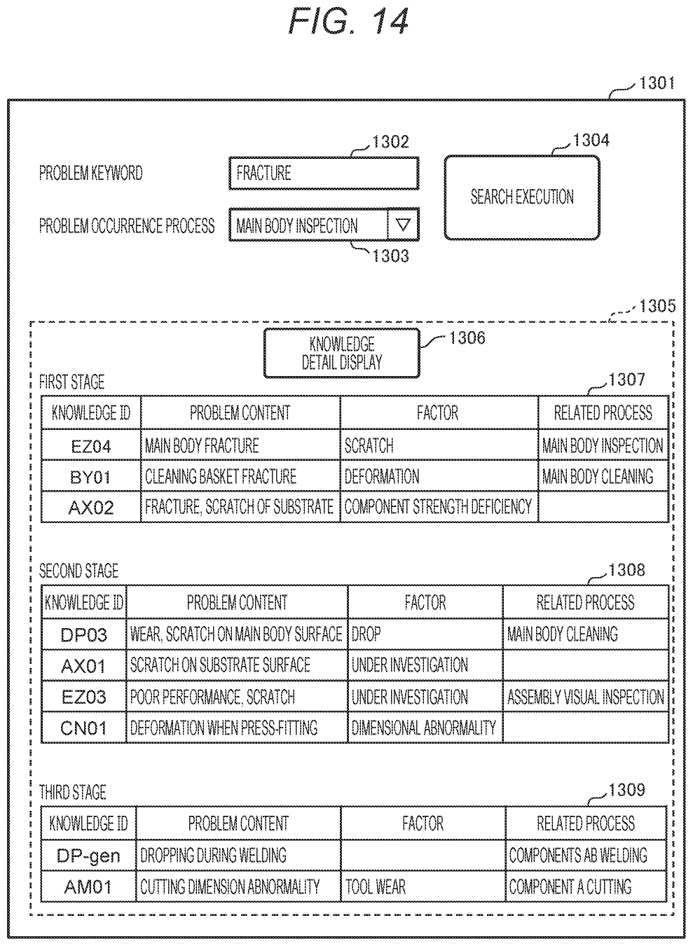

FIG. 14 is a plan view of the knowledge search screen 1301 displayed on the display of the terminal device 121 via the data input/output unit 123.

The knowledge search screen 1301 includes a problem keyword input field 1302, a problem occurrence process selection field 1303, a knowledge search execution button 1304, a search result display field 1305, and a knowledge detail display button 1306.

The problem keyword input field 1302 is displayed in a state where a user can input an arbitrary character string. The initial state is blank. In the problem keyword input field 1302, contents of a problem occurred in the production line are input.

In the problem occurrence process selection field 1303, <process name> of the process table T4 (FIG. 5) can be displayed as a selectable pull-down menu. Here, the user selects a process in which the problem input in the problem keyword input field 1302 has occurred in the production line. In the field of the problem occurrence process selection field 1303, one <process name> selected by the user from the process table T4 is displayed.

A click of the knowledge search execution button 1304 serves as a command to execute the search processing by the search unit 104.

Although nothing is displayed in the initial state in the search result display field 1305, after the search processing is executed, as illustrated in FIG. 14, the result of the search processing is displayed in the first-stage display field 1307, the second-stage display field 1308, and the third-stage display field 1309 in a state where each record can be selected.

When the knowledge detail display button 1306 is clicked, if there is a record selected in the search result display field 1305, the data input/output unit 123 opens the knowledge registration screen 1001 (FIG. 11) in a state where the record is displayed.

[Search Processing]

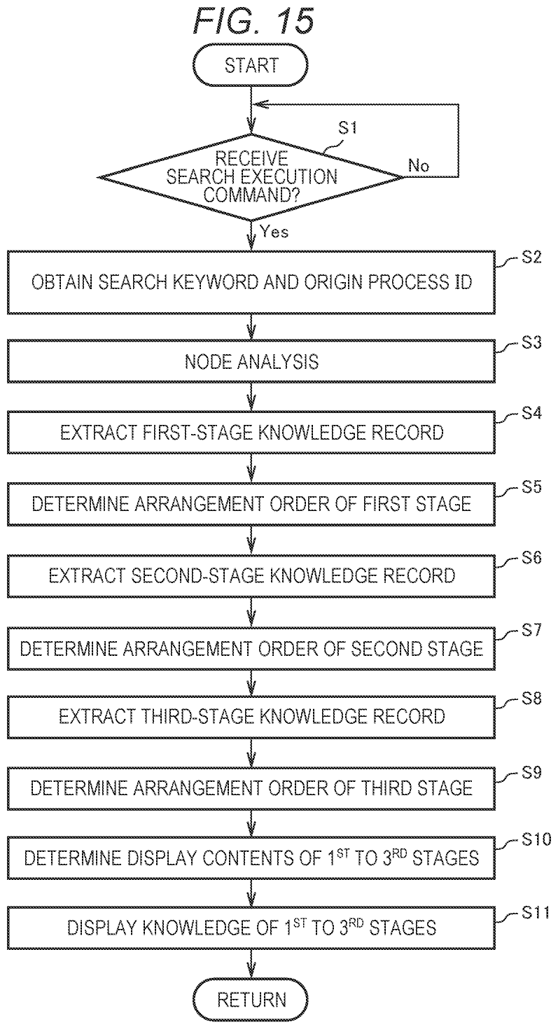

FIG. 15 is a flowchart illustrating search processing executed by the search unit 104. First, in response to receiving a search execution command by the knowledge search execution button 1304 (FIG. 14) being clicked as a trigger (Yes in step S1), the search unit 104 acquires a search condition (step S2). Specifically, the search condition receives the character string input in the problem keyword input field 1302 illustrated in FIG. 14 as the problem keyword. The problem keyword is input by the user in simple words of the contents of a problem that has occurred in the production line. Further, <process name> selected in the problem occurrence process selection field 1303 is received as a problem occurrence process. In this case, specifically, <process ID> (origin process ID) extracted from the process table T4 (FIG. 5) based on the selected problem occurrence process is received. The problem occurrence process is <process name> indicating a process in the production line in which the problem has occurred input as the problem keyword.

Next, the search unit 104 performs node analysis (step S3). Next, the search unit 104 extracts the first-stage knowledge record (step S4). “Knowledge record” is a record registered in the knowledge table T8 (FIG. 9). Next, the search unit 104 determines the arrangement order of the first stage (step S5). Next, the search unit 104 extracts a second-stage knowledge record (step S6). Next, the search unit 104 determines the arrangement order of the second stage (step S7). Next, the search unit 104 extracts the knowledge record of the third stage (step S8). Next, the search unit 104 determines the arrangement order of the third-stage knowledge records (step S9). Next, the search unit 104 determines the display contents of the first to third stages (step S10). Next, the search unit 104 displays the display contents of the first to third stages determined as described above in the search result display field 1305 (FIG. 14) (step S11). As described above, the search processing ends, and a standby state starts. In the following, steps S4 and S5 are referred to as a first search, steps S6 and S7 are referred to as a first second search, and steps S8 and S9 are referred to as a second second search.

[Node Analysis]

Here, details of the node analysis (step S3) will be described. FIG. 16 illustrates an inter-process node number table T15 (FIG. 3). In the inter-process node number table T15, <origin process ID>, <process ID>, <node type>, and <node number> are registered in association with each other.

<Origin process ID> and <process ID> are any values registered as <process ID> in the process table T4 (FIG. 5).

The inter-process node number table T15 (FIG. 3) is information in which “closeness” considering a causal relationship between processes is defined by <node type> and <node number> on the basis of the process order table T5 (FIG. 6) for brute-force pairs of all <process IDs> (<origin process ID>) stored in the process table T4 and all <process IDs> including itself. <Node type> and <node number> are concepts that define “closeness” in consideration of causality between processes. That is, <node number> is a numerical value representing the closeness between processes, and <node type> indicates a type of <node number>.

Here, the definition of “closeness” in the first embodiment will be described. First, a relationship of a process with respect to another process at a certain origin is divided into three types of (a) : a process that is the same as or upstream of the origin in the same production line, (b): a process that is downstream of the origin in the same production line, and (c): a process of another factory or the like that is not in the same production line. In the first embodiment, it is defined that the process is close to the process of the origin in the order of (a), (c), and (b).

The reason why (c) is set in the order from (b) is that a causal relationship between a problem and a factor is considered. It is based on the idea that knowledge information about similar processes present in other manufacturing lines is more likely to include a solution to a problem that occurred in the origin process than knowledge information about processes downstream of the origin process. However, this idea is an example of defining the arrangement order of the knowledge records, and the closeness may be defined by another idea.

In the inter-process node number table T15 (FIG. 3), <node type> and <node number> are defined and stored as follows for <process ID> with respect to <origin process ID>.

In a case where <process ID> for <origin process ID> is type (a), it is assumed that <node type>=0, and <node number>=0, 1, 2, 3, . . . from the origin toward the upstream. In a case of the type (b), it is assumed that <node type>=2, and <node number> is numbered so as to be larger toward the downstream side starting from <node number>+2 on the most upstream side. Here, the reason why <node number> starts from <node number>+2 on the most upstream side is to allocate <node number>+1 on the most upstream side to (c) in rearrangement of records to be described later.

The inter-process node number table T15 (FIG. 3) can be automatically generated based on the process order table T5 (FIG. 6) by this definition.

In addition, in step S3, the following views are generated. FIG. 17 is a conceptual diagram of the most upstream node number view V16. The most upstream node number view V16 is obtained by extracting a record having the maximum <node number> at <node type>=“0” for each <origin process ID> from the inter-process node number table T15 and arranging <origin process ID> and <node number> in association with each other.

FIG. 18 is a conceptual diagram of the node number classification view V17. The node number classification view V17 is a record group in which <classification ID> of the process classification table T6 (FIG. 7) is combined with each record of the inter-process node number table T15 (FIG. 16) using <process ID> as a key, and <origin process ID>, <node number>, <process ID>, and <classification ID> are arranged in association with each other.

FIG. 19 is a conceptual diagram of the nearest classification view V18. The nearest classification view V18 is a record group obtained by extracting a record in which <node number> is the smallest in each <classification ID> with respect to <origin process ID> from the node number classification view V17.

Note that the values of the inter-process node number table T15 (FIG. 16), the most upstream node number view V16 (FIG. 17), the node number classification view V17 (FIG. 18), and the nearest classification view V18 (FIG. 19) can be determined regardless of the search condition received in step S2. Therefore, the processing in step S3 may be executed independently by using, as a trigger, opening of the knowledge search screen 1301 by the user or updating of the process information by the server administrator, in addition to using the receiving of the search execution command as a trigger.

For the inter-process node number table T15 (FIG. 16), the concept of the definition of “closeness” considering the causal relationship between processes includes various approaches such as closeness of an implementation location and closeness of arrangement of a target component, and the like. <Node type> and the <node number> may be determined according to a definition other than the definitions described above, and the <node number> may be a real number with a decimal point instead of an integer.

In addition, for example, an arbitrary numerical value may be manually registered as a value of <node number> by a server administrator. In this case, the inter-process node number table T15 may be stored in the process information storage unit 109 of the database 107 by the server administrator before the operation of the production knowledge management system is started.

Details of steps S4 to S9 will be described below.

[Knowledge Record Extraction: First Stage (First Search)]

In step S4, the knowledge record strongly related to the problem keyword serving as the search keyword is extracted from the knowledge table T8 (FIG. 9), and the first-stage candidate view V19 illustrated in FIG. 20 is generated.

The first-stage candidate view V19 is configured by associating <problem occurrence process ID>, <first-stage knowledge ID>, and <first-stage classification ID>. <Problem occurrence process ID> is <process ID> indicating a process in which a problem serving as a problem keyword has occurred. <First-stage knowledge ID> is <knowledge ID> for specifying the knowledge record extracted as the first stage from the knowledge table T8 (FIG. 9). <First-stage classification ID> is <classification ID> associated with <first-stage knowledge ID> in the knowledge classification table T9 (FIG. 10).

Specifically, the processing here determines whether or not the problem keyword obtained as a search keyword is included in the character string of <problem content> in the knowledge table T8, and extracts the knowledge record included therein.

In the sample of the first embodiment, a knowledge record (<knowledge ID>=“AX02”, “BY01”, and “EZ04”) including the problem keyword “fracture” in <problem content> is extracted as <first-stage knowledge ID> of the first-stage candidate view V19 (FIG. 20).

In addition, <classification ID> obtained by combining the knowledge classification table T9 (FIG. 10) with <knowledge ID> as a combination key with respect to the obtained <first-stage knowledge ID> is set as <first-stage classification ID>.

In the sample of the present embodiment, for example, for <knowledge ID> of “BY01”, there are two records of <classification ID>=“KK6” and “KS2” in the knowledge classification table T9 (FIG. 10). Therefore, there are two records for <first-stage knowledge ID>=“BY01” of the first-stage candidate view V19 (FIG. 20) also has 2 records.

In step S5, the knowledge records extracted in the first-stage candidate view V19 are rearranged in the order of “closeness” between processes on the basis of the nearest classification view V18 (FIG. 19), and the first-stage arrangement order determination view V20 illustrated in FIG. 21 is generated.

The first-stage arrangement order determination view V20 (FIG. 21) is obtained by adding the columns of <first-stage node number> and <first-stage process ID> to the first-stage candidate view V19 (FIG. 20) and excluding <first-stage classification ID>.

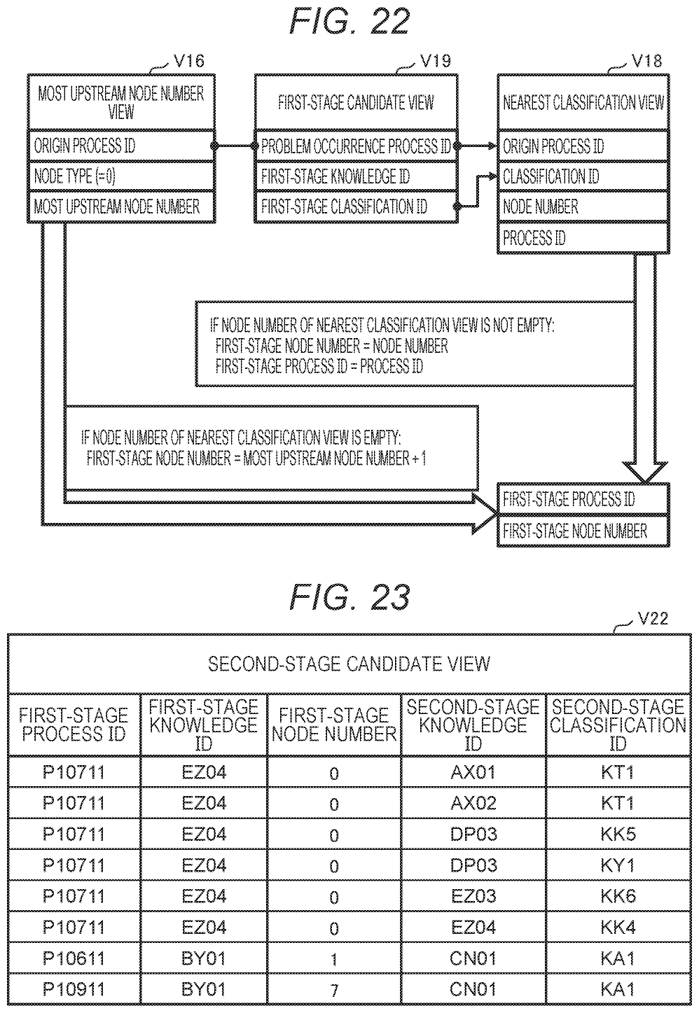

A method of determining <first-stage node number> and <first-stage process ID> will be described below using the conceptual diagram illustrated in FIG. 22. First, the first-stage candidate view V19 (FIG. 20) and the nearest classification view V18 (FIG. 19) are externally combined with <problem occurrence process ID> and <origin process ID> serving as a first combination key and <first-stage classification ID> and <classification ID> serving as a second combination key.

When <node number> obtained from the nearest classification view V18 (FIG. 19) exists in this external combination, <node number> can be obtained as <first-stage node number>, and <process ID> can be obtained as <first-stage process ID>.

On the other hand, when <node number> obtained from the nearest classification view V18 (FIG. 19) does not exist in this external combination, the first-stage candidate view V19 (FIG. 20) and the most upstream node number view V16 (FIG. 17) can be combined using <problem occurrence process ID> and <origin process ID> as combination keys, and <most upstream node number>+1 obtained from the most upstream node number view V16 (FIG. 17) can be obtained as <first-stage node number>.

In the sample of the first embodiment, for example, for a record of <first-stage knowledge ID>=“AX02” and <classification ID>=“KT1” of the first-stage candidate view V19 (FIG. 20), a process record of “<origin process ID>=‘P10711’ ‘and’ <classification ID>=‘KT1’” do not exist in the nearest classification view V18 (FIG. 18). Therefore, <first-stage process ID> remains blank. Further, from the most upstream node number view V16 (FIG. 17), since <most upstream node number>=“4” (FIG. 18) of <origin process ID>=“P10711”, <first-stage node number>=4+1=“5” is obtained.

[Knowledge Record Extraction: Second Stage (First Second Search)]

In step S6, the knowledge record strongly related to the knowledge record obtained in the first-stage arrangement order determination view V20 (FIG. 21) is extracted from the knowledge table T8 (FIG. 9), and the second-stage candidate view V22 illustrated in FIG. 23 is generated.

In the second-stage candidate view V22, <first-stage process ID>, <first-stage knowledge ID>, <first-stage node number>, <second-stage knowledge ID>, and <second-stage classification ID> are associated with each other.

Here, a value of <factor> included in the first related knowledge record group that is a data group obtained in the processing of [knowledge record extraction: first stage] is obtained as a search keyword. Specifically, first, for each record of the first-stage arrangement order determination view V20 (FIG. 21), a value of <factor> obtained by combining with <knowledge ID> of the knowledge table T8 (FIG. 9) is obtained as a search keyword with <first-stage knowledge ID> as a key.

Next, it is determined whether or not the value of the search keyword is included in the character string of <problem content> in the knowledge table T8 (FIG. 9), and <knowledge ID> of the knowledge record including the value is extracted as <second-stage knowledge ID>.

In the sample of the first embodiment, for example, for <knowledge ID>=“BY01”, a knowledge record (<knowledge ID>=“CN01”) including <factor>=“deformation” in <problem content> is extracted as <second-stage knowledge ID> (FIG. 23).

In addition, <classification ID> obtained by combining the knowledge classification table T9 (FIG. 10) with <knowledge ID> as a combination key with respect to the obtained <second-stage knowledge ID> is set as <second-stage classification ID>.

In the sample of the first embodiment, for example, for the <knowledge ID> of “CN01”, since there is a record of <classification ID>=“KA1” in the knowledge classification table T9 (FIG. 10), <second-stage classification ID>=“KA1” is obtained (FIG. 23).

In step S7, the knowledge records extracted in the second-stage candidate view V22 (FIG. 23) are rearranged in order of “closeness” between processes on the basis of the nearest classification view V18 (FIG. 19), and the second-stage arrangement order determination view V23 illustrated in FIG. 24 is generated.

The second-stage arrangement order determination view V23 is obtained by adding the columns of <second-stage node number> and <second-stage process ID> to the second-stage candidate view V22 and excluding <second-stage classification ID>.

Hereinafter, a method of determining <second-stage node number> and <second-stage process ID> will be described using the conceptual diagram illustrated in FIG. 25. First, the second-stage candidate view V22 (FIG. 23) and the nearest classification view V18 (FIG. 19) are externally combined with <first-stage process ID> and <origin process ID> serving as a first combination key and <second-stage classification ID> and <classification ID> serving as a second combination key.

When <node number> obtained from the nearest classification view V18 (FIG. 19) exists in this external combination, <node number> is obtained as <second-stage node number>, and <process ID> is obtained as <second-stage process ID>.

On the other hand, when <node number> obtained from the nearest classification view V18 (FIG. 19) does not exist in this external combination, the second-stage candidate view V22 (FIG. 23) and the most upstream node number view V16 (FIG. 17) are combined using <first-stage process ID> and <origin process ID> as combination keys, and <most upstream node number>+1 obtained from the most upstream node number view V16 (FIG. 17) is obtained as <second-stage node number>.

In the sample of the first embodiment, for example, for a record of <first-stage process ID>=“P10611”, <second-stage knowledge ID>=“CN01”, and <classification ID>=“KA1” of the second-stage candidate view V22 (FIG. 23), a record of a process of “<origin process ID>=‘P10611’” and “<classification ID>=‘KA1’” does not exist in the nearest classification view V18 (FIG. 19), and thus <second-stage process ID> remains blank. Further, from the most upstream node number view V16 (FIG. 17), since <most upstream node number>=“1” for <first-stage process ID>=“P10611” (FIG. 18), <first-stage node number>=1+1=“2”d.

[Knowledge Record Extraction: Third Stage (Second Second Search)]

In step S8, the knowledge record “strongly related” to the knowledge record obtained in the second-stage arrangement order determination view V23 (FIG. 24) is extracted from the knowledge table T8 (FIG. 9), and the third-stage candidate view V25 illustrated in FIG. 26 is generated.

In the third-stage candidate view V25, <first-stage process ID>, <first-stage knowledge ID>, <first-stage node number>, <second-stage process ID>, <second-stage knowledge ID>, <second-stage node number>, <third-stage knowledge ID>, and <third-stage classification ID> are associated with each other.

Here, a value of <factor> included in the second related knowledge record group that is a data group obtained in the processing of [knowledge record extraction: second stage] is obtained as a search keyword. Specifically, first, for each record of the second-stage arrangement order determination view V23 (FIG. 24), a value of <factor> obtained by combining with <knowledge ID> of the knowledge table T8 (FIG. 9) is obtained as a search keyword with <second-stage knowledge ID> as a key.

Next, it is determined whether or not the value of the search keyword is included in the character string of <problem content> in the knowledge table T8 (FIG. 9), and <knowledge ID> of the knowledge record including the value is extracted as <third-stage knowledge ID>.

In the sample of the first embodiment, for <second-stage knowledge ID>=“DP03”, for example, a knowledge record (<knowledge ID>=“DP-gen”) including <factor>=“drop” in <problem content> is extracted as <third-stage knowledge ID> (FIG. 25).

In addition, <classification ID> obtained by combining the knowledge classification table T9 (FIG. 10) with <knowledge ID> as a combination key with respect to the obtained <third-stage knowledge ID> is set as <third-stage classification ID>.

In the sample of the present embodiment, for example, for <knowledge ID>=“DP-gen”, since there is a record of <classification ID>=“KS1” in the knowledge classification table T9 (FIG. 10), <third-stage classification ID>=“KS1” is obtained (FIG. 23).

In step S9, the knowledge records extracted in the third-stage candidate view V25 (FIG. 26) are rearranged in order of “closeness” between processes on the basis of the nearest classification view V18 (FIG. 19), and a third-stage arrangement order determination view V26 illustrated in FIG. 27 is generated.

The third-stage arrangement order determination view V26 is obtained by adding the columns of <third-stage node number> and <third-stage process ID> to the third-stage candidate view V25 (FIG. 26) and excluding <third-stage classification ID>.

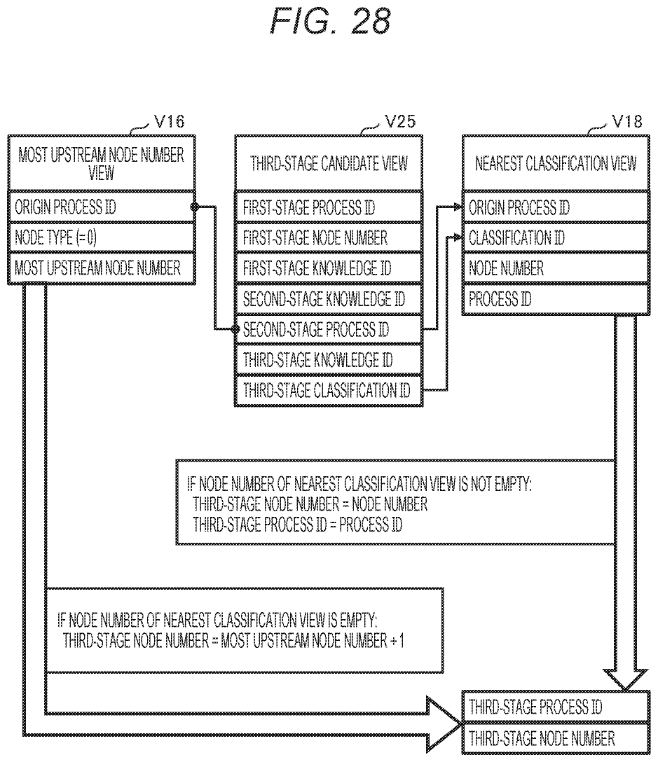

Hereinafter, a method of determining <third-stage node number> and <third-stage process ID> will be described using the conceptual diagram illustrated in FIG. 28. First, the third-stage candidate view V25 (FIG. 26) and the nearest classification view V18 (FIG. 19) are externally combined with <second-stage process ID> and <origin process ID> serving as a first combination key and <third-stage classification ID> and <classification ID> serving as a second combination key.

When <node number> obtained from the nearest classification view V18 exists in this external combination, <node number> is obtained as <third-stage node number>, and <process ID> is obtained as <third-stage process ID>.

On the other hand, when <node number> obtained from the nearest classification view V18 (FIG. 19) does not exist in this external combination, the third-stage candidate view V25 (FIG. 26) and the most upstream node number view V16 (FIG. 17) are combined using <second-stage process ID> and <origin process ID> as combination keys, and <most upstream node number>+1 obtained from the most upstream node number view V16 (FIG. 17) is obtained as <third-stage node number>.

In the sample of the present embodiment, for example, for a record of <second-stage process ID>=“P20411”, <third-stage knowledge ID>=“DP-gen”, and <classification ID>=“KY1” of the third-stage candidate view V25 (FIG. 26), since a process record of <origin process ID>=“P20411” and <classification ID>=“KY1” has <node number>=“0” and process ID =“P20411” in the nearest classification view V18 (FIG. 19), <third-stage process ID>=“P20411” and <third-stage node number>=“0” are obtained.

[Creation and Display of Search Result on First to Third Stages]

Details of step S10 will be described. In step S10, the first-stage arrangement order determination view V20 (FIG. 20), the second-stage arrangement order determination view V23 (FIG. 24), and the third-stage arrangement order determination view V26 (FIG. 27) are displayed on the knowledge search screen 1301 (FIG. 14) while maintaining the order of records. In this case, a case where the same <knowledge ID> appears again is excluded, and <first-stage process ID>, <second-stage process ID>, and <third-stage process ID> are displayed on the knowledge search screen 1301 (FIG. 14) with <first-stage knowledge ID>, <second-stage knowledge ID>, and <third-stage knowledge ID> as keys. In addition, <problem content> and <factor> extracted from the knowledge table T8 by combining with the <knowledge ID> of the knowledge table T8 (FIG. 9) are displayed on the knowledge search screen 1301 (FIG. 14). In this case, in the search result display field 1305 of the knowledge search screen 1301 (FIG. 14), the information on the first stage is displayed in the first-stage display field 1307, the information on the second stage is displayed in the second-stage display field 1308, and the information on the third stage is displayed in the third-stage display field 1309.

FIG. 14 illustrates an example of a screen display state when step S10 ends. In this example, <process name> associated with <first-stage process ID>, <process name> associated with <second-stage process ID>, and <process name> associated with <third-stage process ID> are expressed as “related processes”.

In this manner, a list of knowledge records that serve as reference of factors of the problem that has occurred is displayed in an easily viewable state for the user.

According to the production knowledge management system 101 described above, the process table T4 (FIG. 5) and the knowledge table T8 (FIG. 9) may easily include in records proper nouns such as a field terminology used only in a specific production line. On the other hand, <classification name> registered in the classification master table T3 (FIG. 4) is configured by a general-purpose term (general name) that is commonly used in production lines of the same type of products. Therefore, if the classification master table T3 (FIG. 4) is prepared, the process in the production line and the knowledge in the knowledge table T8 (FIG. 9) can be associated later using the process classification table T6 (FIG. 7) and the knowledge classification table T9 (FIG. 10). That is, by using the classification master table T3 (FIG. 4), it is possible to perform the search processing by associating one knowledge with another knowledge for the first time at the time of executing the search. Therefore, the search processing can be performed even if a tree structure that links certain knowledge and other knowledge is not precisely generated in advance. Therefore, according to the production knowledge management system 101, knowledge search can be performed using the database 107 that is easily constructed.

According to the production knowledge management system 101, the search processing is performed not only once in the first search of the first stage but also in the first second search of the second stage and in the second second search of the third stage. However, the present invention is not limited thereto, and only one first search of the first stage may be performed. However, according to the production knowledge management system 101, the necessary knowledge can be easily searched from a wide range by executing the second search. In this case, in the above example, the second search (the second second search) based on the result of the second search (the first second search) that has been most recently executed is performed once. The present invention is not limited to this, and the second search may be performed only once, and the second second search may not be executed. Alternatively, the number of times of the second search may be increased, and the third second search, the fourth second search, and the like may be executed.

In addition, according to the production knowledge management system 101, a knowledge record having a high possibility as a factor of the problem that has occurred is displayed in a high order, and a related process can be presented.

Furthermore, according to the production knowledge management system 101, a knowledge record registered regarding a problem of a production line different from the production line in which the problem has occurred can be presented as reference information with a relatively low priority.

Furthermore, according to the production knowledge management system 101, since the registration of knowledge is simple, the latest knowledge obtained on site can be accumulated by a plurality of persons.

According to the first embodiment, since the search without omission of the production knowledge information can be performed, it is effective for the discussion of failure mode EA (FMEA) and fall tree analysis (FTA) in the design stage of the production line.

Further, according to the first embodiment, it is possible to register the information little by little from a stage where the information is not determined.

### Second Embodiment

Next, the second embodiment of the present invention will be described.

In the following embodiments, differences from the first embodiment will be mainly described, and the same reference numerals as those of the first embodiment will be used for components and the like common to the first embodiment.

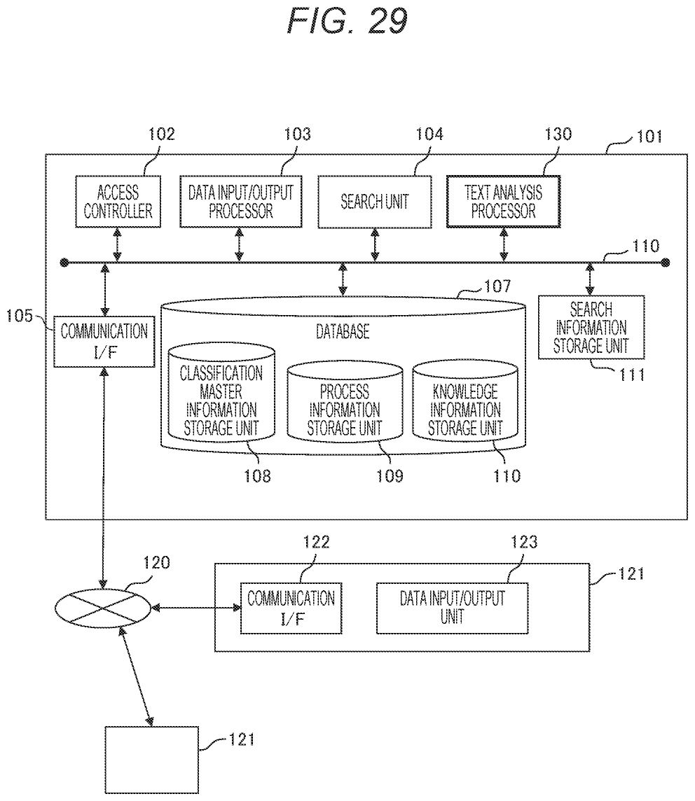

FIG. 29 is a functional block diagram of the production knowledge management system 101 according to the second embodiment. The production knowledge management system 101 is different from that of the first embodiment in that a text analysis processor 130 is added as a functional block. The function of the text analysis processor 130 is also realized by processing executed by the production knowledge management system 101 based on the production knowledge management program 20.

The text analysis processor 130 executes processing of extracting <knowledge ID> including a content strongly related to the search keyword in <problem content> from the knowledge table T8 (FIG. 9) by a processing procedure in the following order of (1) to (6) which is a natural language processing method.

(1) A word is extracted by the morphological analysis of <problem content> of each record of the knowledge table T8.

(2) By the term frequency-inverse document frequency (TF-IDF), n vectors Xn (m×1) indicating the importance of all words (m items) extracted from <problem content> (n items) of all records of the knowledge table T8 with respect to <problem content> of each record are generated.

(3) By latent semantic analysis (LSA), a k×n orthogonal matrix D of the degree of correlation around X (n items) and topics (k items) and an m×k orthogonal matrix T of the degree of correlation around words (m items) and topics (k items) are generated.

(4) For the search keyword, a search word group is extracted by morphological analysis.

(5) A strongly related topic is extracted by collating a search word group with the orthogonal matrix T, and a strongly related vector Xn is extracted by collating the extracted topic with the orthogonal matrix D.

(6) The <knowledge ID> of a record corresponding to the vector Xn is obtained from the knowledge table T8.

In addition, in the second embodiment, the contents of the search processing of the first embodiment described above are partially changed as in the following (a) to (c).

(a) In steps S4 and FIG. 20, the processing by the text analysis processor 130 is executed using a problem keyword as a search keyword, and the obtained <knowledge ID> is set as <first-stage knowledge ID> of the first-stage candidate view V19 (FIG. 20).

(b) In steps S6 and FIG. 23, each record of the first-stage arrangement order determination view V20 (FIG. 21) is combined with <knowledge ID> of the knowledge table T8 (FIG. 9) by using <first-stage knowledge ID> as a key. Then, the processing by the text analysis processor 130 is executed using a value of <factor> as a search keyword, and the obtained <knowledge ID> is set as <second-stage knowledge ID> of the second-stage candidate view V22 (FIG. 23).

(c) In steps S8 and FIG. 26, a value of <factor> obtained by combining each record of the second-stage arrangement order determination view V23 (FIG. 24) with <knowledge ID> of the knowledge table T8 (FIG. 9) by using <second-stage knowledge ID> as a key is set as a search keyword. Then, the processing by the text analysis processor 130 is executed, and the obtained <knowledge ID> is set as <third-stage knowledge ID> of the third-stage candidate view V25 (FIG. 26).

According to the second embodiment described above, since the search in which the notation fluctuation is absorbed by <problem content> and <factor> of the knowledge table T8 (FIG. 9) is performed, the user does not need to be sensitive for unifying terms when registering the knowledge record in the knowledge table T8.

Note that it is also possible to further improve the accuracy of search by adding processing such as collocation analysis, absorption of notation fluctuation using a dictionary, and stop word exclusion to the text analysis processor 130.

### Third Embodiment

Next, the third embodiment of the present invention will be described.

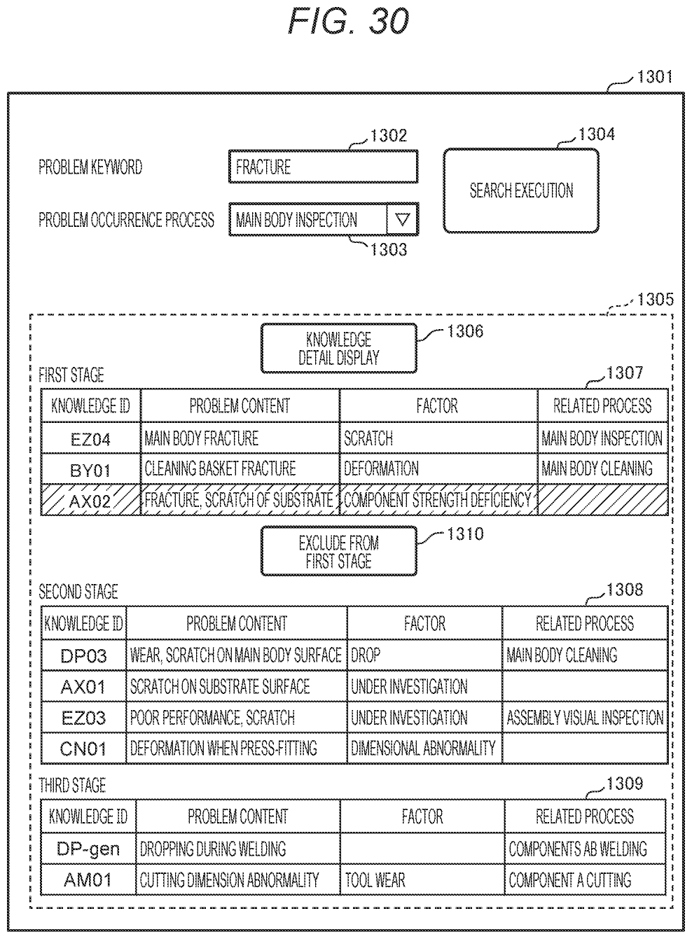

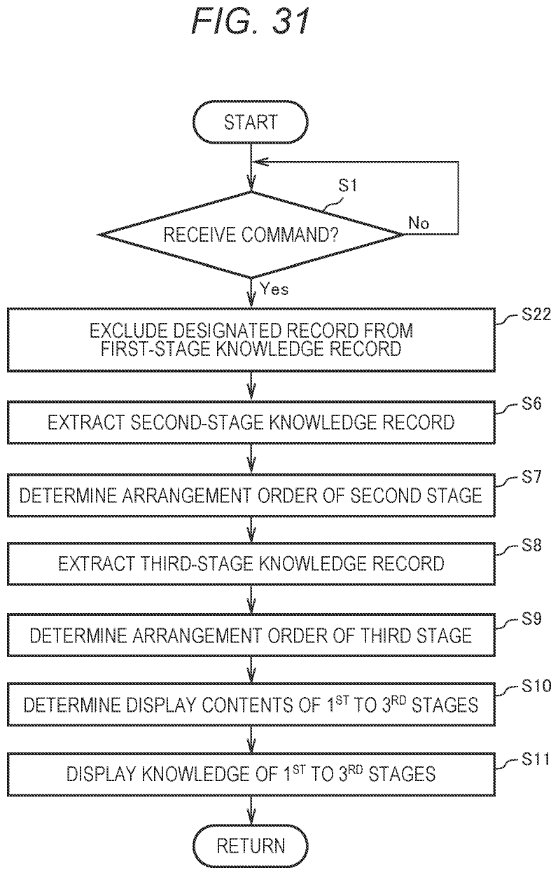

The third embodiment is different from the first embodiment in that, as illustrated in FIG. 30, a first-stage exclusion button 1310 is added to the knowledge search screen 1301 of the first embodiment, and accordingly, a new processing (FIG. 31) is performed.

Basically, the processing of executing steps S1 to

S11 in FIG. 15 by detection of a click of the knowledge search execution button 1304 is common to that of the first embodiment. As a result, a search result as illustrated in FIG. 30 is output.

FIG. 31 is a flowchart illustrating search processing executed by the search unit 104 when the first-stage exclusion button 1310 is clicked. When a record obviously unrelated to a search target intended by the user is extracted in the first stage, the user selects the record in the first-stage display field 1307 of the screen in FIG. 30 (indicated by hatching in the example in FIG. 30). When the instruction to exclude from the result of the first stage is received by clicking the first-stage exclusion button 1310 when the search result as illustrated in FIG. 30 is displayed (Yes in S21), the search unit 104 overwrites the first-stage arrangement order determination view V20 (FIG. 21) with the record set excluding the selected record (S22). Then, the search unit 104 executes the same processing as steps S6 to S11 in FIG. 15 on the basis of the overwritten first-stage arrangement order determination view V20 (FIG. 21). That is, the processing of S6 onward is performed again.

That is, if there is a record instructed to be excluded in the first related knowledge record group in the search result, the second related knowledge record group is specified again in the second search on the basis of the first related knowledge record group excluding the record.

According to the third embodiment, when a record obviously unrelated to the search target intended by the user is extracted in the first stage, it is possible to avoid that a record strongly related to the unrelated record is extracted in the second stage and the third stage, and it becomes difficult to search for target knowledge.

### Fourth Embodiment

Next, the fourth embodiment of the present invention will be described.

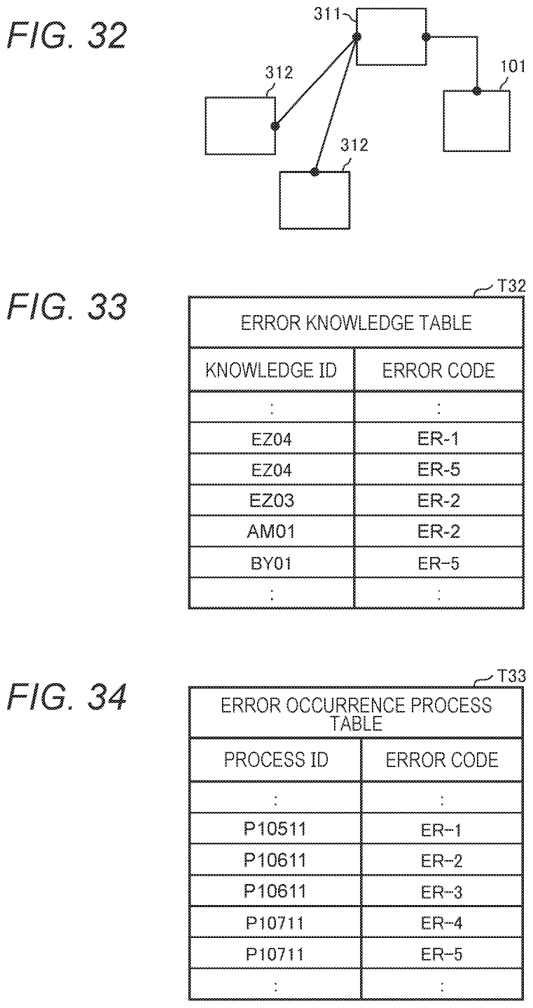

As illustrated in FIG. 32, the fourth embodiment is different from the first embodiment in that the production knowledge management system 101 is connected to a production state monitoring system 311 which is a system for managing a production line via a network, and data can be transmitted and received to and from each other. Here, the production state monitoring system 311 is a system having a function of collecting an error code issued from each manufacturing facility 312 provided in the production line. The error code is a code for specifying a type of a problem which may occur in each manufacturing facility 312.

In addition, in the fourth embodiment, an error knowledge table T32 for registering <knowledge ID> and <error code> in association with each other as illustrated in FIG. 33 is added to the knowledge information storage unit 110 (FIG. 2) of the database 107.

In addition, an error occurrence process table T33 for registering <process ID> and <error code> in association with each other as illustrated in FIG. 34 is added to the process information storage unit 109 (FIG. 2).

In the search processing executed by the search unit 104, the processing of first embodiment is changed in the following points. First, the processing in step S2 (FIG. 15) is changed so that <error code> is received from the production state monitoring system 311 and <process ID> extracted by collation between the received <error code> and the error occurrence process table T33 (FIG. 34) is obtained as <problem occurrence process ID>. As a result, unlike the processing of the first embodiment, it is possible to specify the problem occurrence process without the input work of the user.

Furthermore, the processing in step S4 (FIG. 15) is changed so that the <knowledge ID> extracted by collation between the <error code> received as described above and the error knowledge table T32 (FIG. 33) is set as the <first-stage knowledge ID> of the first-stage candidate view V19 (FIG. 20). As a result, the <first-stage knowledge ID> can be narrowed down by the <error code>.

Other steps S3 and S5 to S11 are the same as those in the first embodiment.

According to the fourth embodiment, when an error code is issued, an input from the user as in the first embodiment is not required. In addition, since the related knowledge record is immediately displayed and the related knowledge record is displayed in the second and third stages, it is possible to improve the efficiency of factor analysis and countermeasures of the user.

Note that the present invention is not limited to the above-described embodiments, and includes various modifications. For example, the above-described embodiments have been described in detail in order to simply describe the present invention, and are not necessarily limited to those having all the described configurations. In addition, a part of the configuration of a certain embodiment can be replaced with the configuration of another embodiment, and the configuration of another embodiment can be added to the configuration of a certain embodiment. In addition, it is also possible to add, delete, and replace other configurations for a part of the configuration of each embodiment.

In addition, a part or all of the above-described configurations, functions, processors, processing means, and the like may be realized by hardware, for example, by designing with an integrated circuit.

In addition, the control lines and the information lines indicate those necessary for the description, and do not necessarily indicate all the control lines and the information lines on the product. In practice, it may be considered that almost all the configurations are connected to each other.

### REFERENCE SIGNS LIST

16 storage medium

20 production knowledge management program

101 production knowledge management system

104 search unit

107 database

T3 classification master table

T4 process table

T5 process order table

T6 process classification table

T8 knowledge table

T9 knowledge classification table

T32 error knowledge table

T33 error occurrence process table

S4, S5 first search

S6, S7 first second search

S8, S9 second second search

V20 first-stage arrangement order determination view (first related knowledge record group)

V23 second-stage arrangement order determination view (second related knowledge record group)

V26 third-stage arrangement order determination view (second related knowledge record group)

1. A production knowledge management system comprising:
a database; and
a search unit which searches the database,
wherein
the database includes:
a classification master table which registers a classification name obtained by classifying processing performed in each process of a production line and a classification ID which is a unique key thereof in association with each other;
a process table which registers a process name of the process and a process ID which is a unique key thereof in association with each other;
a process order table which registers the process ID and a next process ID which is a unique key of a next process of a process indicated by the process ID in association with each other;
a process classification table which registers the process ID and the classification ID in association with each other;
a knowledge table which registers a problem content occurring in each process, a factor thereof, and a knowledge ID that is a unique key thereof in association with each other; and
a knowledge classification table which registers the knowledge ID and the classification ID in association with each other, and
the search unit performs a first search for specifying a first related knowledge record group by receiving a problem keyword and a problem occurrence process, by using the database, narrowing records in the knowledge table by determination of similarity of a character string between the problem keyword and the problem content stored in the knowledge table, and arranging an order of the narrowed records such that a record more related to the classification name in the problem occurrence process or a process upstream of the problem occurrence process in the production line is prioritized.

2. The production knowledge management system according to claim 1, wherein the search unit performs a second search once for specifying a second related knowledge record group by using the database with the factor included in the first related knowledge record group as a search keyword, narrowing records in the knowledge table by determination of similarity of a character string between the factor and the problem content stored in the knowledge table, and arranging an order of the narrowed records such that a record more related to the classification name in the problem occurrence process or a process upstream of the problem occurrence process in the production line is prioritized, or performs the second search at least once again based on a result of the second search performed most recently after performing the second search once.

3. The production knowledge management system according to claim 1, wherein in at least one of the first search and the second search, the records are narrowed by similarity determination of meanings of a search keyword and a problem content registered in the knowledge table by using a natural language processing method.

4. The production knowledge management system according to claim 2, wherein in a case where there is a record instructed to be excluded in the first related knowledge record group specified in the first search, the second related knowledge record group is specified in the second search based on the first related knowledge record group excluding the record.

5. The production knowledge management system according to claim 1, wherein
the database includes:
an error knowledge table which registers an error code for specifying a type of a problem occurring in the production line and the knowledge ID in association with each other; and
an error occurrence process table which registers the error code and the process ID in association with each other, and
the search unit specifies the problem occurrence process using the error occurrence process table by using the error code received from an outside as a key, and specifies the first related knowledge record group using the error knowledge table by using the error code as a key.

6. A production knowledge management method comprising:
using a database including:
a classification master table which registers a classification name obtained by classifying processing performed in each process of a production line and a classification ID which is a unique key thereof in association with each other;
a process table which registers a process name of the process and a process ID which is a unique key thereof in association with each other;
a process order table which registers the process ID and a next process ID which is a unique key of a next process of a process indicated by the process ID in association with each other;
a process classification table which registers the process ID and the classification ID in association with each other;
a knowledge table which registers a problem content occurring in each process, a factor thereof, and a knowledge ID that is a unique key thereof in association with each other; and
a knowledge classification table which registers the knowledge ID and the classification ID in association with each other; and
performing a first search for specifying a first related knowledge record group by receiving a problem keyword and a problem occurrence process, by using the database, narrowing records in the knowledge table by determination of similarity of a character string between the problem keyword and the problem content stored in the knowledge table, and arranging an order of the narrowed records such that a record more related to the classification name in the problem occurrence process or a process upstream of the problem occurrence process in the production line is prioritized.

7. The production knowledge management method according to claim 6, comprising performing a second search once for specifying a second related knowledge record group by using the database with the factor included in the first related knowledge record group as a search keyword, narrowing records in the knowledge table by determination of similarity of a character string between the factor and the problem content stored in the knowledge table, and arranging an order of the narrowed records such that a record more related to the classification name in the problem occurrence process or a process upstream of the problem occurrence process in the production line is prioritized, or performing the second search at least once again based on a result of the second search performed most recently after performing the second search once.

8. The production knowledge management method according to claim 6, wherein in at least one of the first search and the second search, the records are narrowed by similarity determination of meanings of a search keyword and a problem content registered in the knowledge table by using a natural language processing method.

9. The production knowledge management method according to claim 7, wherein in a case where there is a record instructed to be excluded in the first related knowledge record group specified in the first search, the second related knowledge record group is specified in the second search based on the first related knowledge record group excluding the record.

10. The production knowledge management method according to claim 6, wherein
the database includes:
an error knowledge table which registers an error code for specifying a type of a problem occurring in the production line and the knowledge ID in association with each other; and
an error occurrence process table which registers the error code and the process ID in association with each other, and
the method comprising specifying the problem occurrence process using the error occurrence process table by using the error code received from an outside as a key, and specifying the first related knowledge record group using the error knowledge table by using the error code as a key.

11. A production knowledge management program causing a computer to execute:
using a database including:
a classification master table which registers a classification name obtained by classifying processing performed in each process of a production line and a classification ID which is a unique key thereof in association with each other;
a process table which registers a process name of the process and a process ID which is a unique key thereof in association with each other;
a process order table which registers the process ID and a next process ID which is a unique key of a next process of a process indicated by the process ID in association with each other;
a process classification table which registers the process ID and the classification ID in association with each other;
a knowledge table which registers a problem content occurring in each process, a factor thereof, and a knowledge ID that is a unique key thereof in association with each other; and
a knowledge classification table which registers the knowledge ID and the classification ID in association with each other; and
performing a first search for specifying a first related knowledge record group by receiving a problem keyword and a problem occurrence process, by using the database, narrowing records in the knowledge table by determination of similarity of a character string between the problem keyword and the problem content stored in the knowledge table, and arranging an order of the narrowed records such that a record more related to the classification name in the problem occurrence process or a process upstream of the problem occurrence process in the production line is prioritized.

12. The production knowledge management program according to claim 11, causing a computer to execute: performing a second search once for specifying a second related knowledge record group by using the database with the factor included in the first related knowledge record group as a search keyword, narrowing records in the knowledge table by determination of similarity of a character string between the factor and the problem content stored in the knowledge table, and arranging an order of the narrowed records such that a record more related to the classification name in the problem occurrence process or a process upstream of the problem occurrence process in the production line is prioritized, or performing the second search at least once again based on a result of the second search performed most recently after performing the second search once.

13. The production knowledge management program according to claim 11, causing a computer to execute, in at least one of the first search and the second search, narrowing the records by similarity determination of meanings of a search keyword and a problem content registered in the knowledge table by using a natural language processing method.

14. The production knowledge management program according to claim 12, causing a computer to execute, in a case where there is a record instructed to be excluded in the first related knowledge record group specified in the first search, specifying the second related knowledge record group in the second search based on the first related knowledge record group excluding the record.

15. The production knowledge management program according to claim 11, wherein
the database includes:
an error knowledge table which registers an error code for specifying a type of a problem occurring in the production line and the knowledge ID in association with each other; and
an error occurrence process table which registers the error code and the process ID in association with each other, and
the program causing a computer to execute specifying the problem occurrence process using the error occurrence process table by using the error code received from an outside as a key, and specifying the first related knowledge record group using the error knowledge table by using the error code as a key.
